(19) United States
(12) Patent Application Publication
(10) Pub. No.: US 2012/0239334 A1
(43) Pub. Date: Sep. 20, 2012

(54) Sensor Monitoring of a Position Measurement Apparatus by Means of Thermal Noise

(75) Inventor: Guenter Reusing, Niederwerrn (DE)

(73) Assignee: Robert Bosch GmbH, Stuttgart (DE)

(21) Appl. No.: 13/422,480

(22) Filed: Mar. 16, 2012

(30) Foreign Application Priority Data
Mar. 18, 2011 (DE) 10 2011 014 317.3

(51) Int. Cl. G06F 15/00

(52) U.S. Cl. 702/94; 702/150

(57) ABSTRACT

A position measurement apparatus includes a material measure and a scanning apparatus, which can move with respect to the material measure, with the scanning apparatus having at least one receiver turn arrangement, by means of which measurement markings on the material measure can be scanned. The scanning apparatus further includes an evaluation apparatus which can measure the electrical receiver voltage which is pressed on the receiver turn arrangement, in order to produce a position signal therefrom. The evaluation apparatus is designed to determine a noise measure from the receiver voltage, with comparison means furthermore being provided, which can compare the noise measure with a predeterminable tolerance band. The evaluation apparatus further includes an indication means which can indicate that the noise measure is outside the tolerance band.

This application claims priority under 35 U.S.C. §119 to patent application no. DE 10 2011 014 317.3, filed on Mar. 18, 2011 in Germany, the disclosure of which is incorporated herein by reference in its entirety.

### BACKGROUND

The present disclosure relates to a position measurement apparatus.

EP 1 164 358 B1 discloses a position measurement apparatus. The position measurement apparatus comprises a material measure which, for example, may be in the form of a metal ribbon having a multiplicity of measurement markings, which are the same as one another, in the form of rectangular apertures. The measurement markings are arranged at a constant graduation interval along the material measure. Furthermore, a scanning apparatus is provided, having a transmitter and a receiver turn arrangement. The transmitter turn arrangement is supplied with an electrical alternating current, such that it produces an electromagnetic field. The inductive coupling between the transmitter and receiver turn arrangement is dependent on their position with respect to the material measure. The receiver voltage which is induced in the receiver turn arrangement is therefore a measure of the relative position between the scanning apparatus and the material measure. Furthermore, an evaluation apparatus is provided, which can use the receiver voltage to produce a position signal which complies with predetermined standardized requirements, such that, for example, it can be processed further by a machine control system. By way of example, analog sine/cosine signals, incremental TTL signals or digital absolute signals may be used as position signals.

The transmitter and the receiver turn arrangements are in the form of planar coils which, for example, can be produced by means of a photochemical etching process, in order to achieve the preferred short graduation intervals for the material measure. The conductor tracks of the corresponding turns have a very narrow width of, for example, 10 μM. This also applies to their separation. Because of manufacturing inaccuracies, a conductor track can therefore easily be interrupted, or a short circuit can occur between two adjacent conductor tracks. Furthermore, the connection to the evaluation apparatus may be faulty. A faulty turn arrangement such as this is no longer suitable for accurate position determination, and must be segregated. It is known for faulty turn arrangements such as these to be identified by a resistance measurement. This is done by making use of the fact that the above faults lead to a considerable change in the resistance of the turn arrangement.

Said resistance measurement is easily possible during the production of the position measurement device, but is associated with a certain amount of effort. Furthermore, it has been found that the said faults on the turn arrangements may also occur only during the course of operation of the position measurement device. It is therefore desirable for the position measurement apparatus to be able to autonomously carry out said resistance measurement. This is easily possible in the case of the transmitter turn arrangement. A predetermined voltage or a predetermined current is selectively applied thereto, in such a way that this is sufficient to measure current resulting therefrom and/or the voltage resulting therefrom, in order to determine the resistance of the transmitter turn arrangement.

This procedure is not easily possible for the receiver turn arrangement. In this case, it must be remembered that the receiver voltage induced in the receiver turn arrangement is very small, as a result of which any change in the circuitry of the receiver turn arrangement can have a negative influence on the measurement result. In particular, it is possible only with difficulty to supply current to the receiver turn arrangement for the resistance measurement.

The object of the disclosure is therefore to allow said resistance measurement on the receiver turn arrangement to be carried out autonomously by the position measurement apparatus, without the position determination deteriorating.

### SUMMARY

According to the disclosure, this object is achieved in that the evaluation apparatus is designed to determine a noise measure from the receiver voltage, with comparison means furthermore being provided, which can compare the noise measure with a predeterminable tolerance band, with the evaluation apparatus furthermore having indication means which can indicate that the noise measure is outside the tolerance band. In this case, use is made of the fact that every resistance produces thermal noise, also referred to as Johnson Nyquist noise. This is essentially white noise, with the noise voltage being proportional to the square root of the resistance value of the receiver turn arrangement. The noise voltage is admittedly very small, but the evaluation apparatus which is provided in any case is able to evaluate this thermal noise. In particular, there is no need to connect the receiver turn arrangement to a voltage or current source for resistance measurement. The evaluation comprises determination of a noise measure from the noise voltage, with this noise measure being compared with a predeterminable to tolerance band. If the noise measure is outside the tolerance band, then this is indicated by an indication means, for example an indication LED or a fault signal on a separate fault signal connection.

Advantageous developments and improvements of the disclosure are described herein.

The noise measure may be the square of the receiver voltage averaged over a predeterminable time period. This noise measure is directly proportional to the resistance to be measured of the receiver turn arrangement. The permissible tolerance limits can therefore be determined particularly easily. This noise measure is preferably determined digitally.

The noise measure may be the magnitude of the receiver voltage averaged over a predeterminable time period. This noise measure can be determined in a simple manner by a rectifier operating on an analog basis, followed by analog low-pass filtering.

The evaluation apparatus may have an analog/digital converter for measurement of the receiver voltage, with the noise measure being determined and compared with the tolerance band digitally. In the case of this position measurement apparatus, the additional complexity for monitoring, according to the disclosure, the receiver turn arrangement comprises a pure software modification in the known evaluation apparatus. The additional costs are negligible in comparison to the known position measurement apparatus.

The evaluation apparatus may have a bandpass filter, thus allowing the receiver voltage to be filtered before determination of the noise measure. From the start, it is impossible to preclude the possibility of the position measurement apparatus being moved during the evaluation according to the disclosure of the thermal noise, or of voltages being induced in the receiver turn arrangement in some other manner. These disturbance voltages would corrupt the evaluation of the thermal noise. However, it can be predicted that said disturbance voltages will occur only in specific frequency ranges, while the virtually white thermal noise occurs distributed uniformly over all frequency ranges. The bandpass filtering therefore selects those frequency ranges for which there is a high probability that they will be free of voltages other than the noise voltage. The bandpass filtering is preferably carried out digitally, although analog filtering is likewise feasible.

The evaluation apparatus can be designed such that it can check the receiver voltage to determine whether it has the same spectral composition as white noise. This makes it possible to completely preclude the monitoring of the receiver turn arrangement being corrupted by disturbance voltages. If the above bandpass filtering is carried out, the check of the spectral composition is preferably restricted to the filtered frequency band.

The scanning apparatus may have a temperature sensor for measurement of the temperature of the receiver turn arrangement, in which case the tolerance band can be corrected as a function of the measured temperature. It is known that the noise voltage of the thermal noise varies in proportion to the square root of the absolute temperature of the resistance. At the same time, it must be expected that the position measurement apparatus will be used in different ambient temperatures. The temperature measurement makes it possible to correct the predeterminable tolerance band such that the same evaluation result is always achieved, irrespective of the ambient temperature. In this case, it should be noted that the resistance change which is caused by a faulty receiver terminal arrangement is generally so great that the proposed temperature compensation is not required for normal ambient temperature fluctuations.

The scanning apparatus may have a transmitter turn arrangement which is connected to a transmitter current source, in which case the connection to the transmitter current source can be blocked during determination of the noise measure. Variable currents in the transmitter turn arrangement induce voltages in the receiver turn arrangement, which are superimposed on the thermal noise and also disturb the monitoring of the thermal noise according to the disclosure. These disturbance voltages can be suppressed by switching off the current source. At this point, the term current source means both the current-controlled and the voltage-controlled feeding of electrical alternating current into the transmitter turn arrangement.

The scanning apparatus can be designed such that the indication means can set the position signal to a state which indicates a malfunction of the position measurement apparatus. If the position signal is an analog sine/cosine signal, the aim, in particular, is to set both signals to zero. This signal state is precluded by definition during normal operation. It also indicates a malfunction of the position measurement device. A corresponding fault indication is known from DE 10 2006 012 074 A1.

### BRIEF DESCRIPTION OF THE DRAWINGS

The disclosure will be explained in more detail in the following text with reference to the attached drawings, in which:

FIG. 1 shows a block diagram of a first embodiment of a position measurement apparatus according to the disclosure; and

FIG. 2 shows a block diagram of a second embodiment of a position measurement apparatus according to the disclosure.

### DETAILED DESCRIPTION

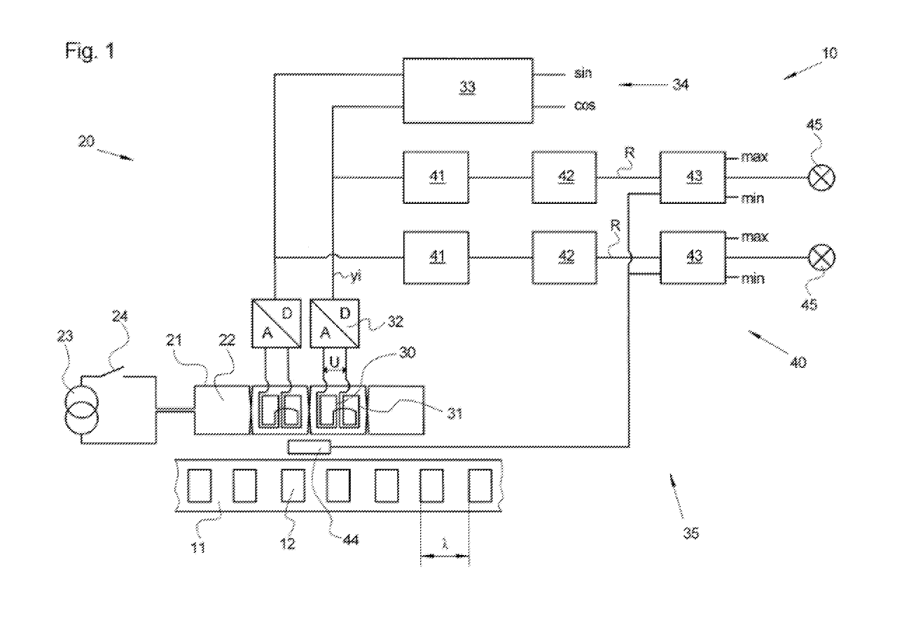

FIG. 1 shows a first embodiment of a position measurement apparatus 10 according to the disclosure. The position measurement apparatus 10 has a material measure 11 in the form of a metal ribbon, which is provided with a multiplicity of measurement markings 12, which are the same as one another, in the form of rectangular apertures. The measurement markings 12 have a constant graduation interval λ, and each have a width corresponding to half the graduation interval λ/2.

The transmitter and the receiver turn arrangements 21; 30 are (contrary to the illustration) arranged parallel, a short distance apart, opposite the measurement markings 12. The conductor tracks of the turn arrangements 21; 30 run on a plurality of parallel planes, for which reason they are also referred to as planar turns. The transmitter turn arrangement 21 comprises a multiplicity of mutually crossing conductor tracks, which define a plurality of transmitter areas 22. One receiver coil pair 31 of the receiver turn arrangement 30 is arranged within each transmitter area 22. The essentially identical individual cores of a receiver core pair 31 are connected in series in opposite turn directions, with their separation corresponding to half the graduation interval λ/2 of the material measure 11.

The position measurement apparatus 10 has two measurement channels, specifically a sine channel and a cosine channel, which each produce a signal U offset in phase through 90°. For this purpose, the receiver coil pairs 31, whose designs are identical are each offset through one quarter of the graduation interval λ/4 with respect to the measurement graduation. Contrary to the illustration, each measurement channel has a plurality of series-connected receiver coil pairs 31 as a result of which the receiver voltage U is high. The first and the final transmitter areas 22 of the transmitter turn arrangement 21 do not have a receiver coil pair 31, because the transmitter field there has different characteristics, because of edge effects, from the field in the region of the other transmitter areas 22.

During measurement operation, the transmitter turn arrangement 21 is supplied with an alternating current at a frequency of, for example, 100 kHz from a transmitter current source 23, with the switch 24 being closed in this operating state. This alternating current induces a receiver voltage U in the receiver turn arrangement 30, the amplitude of which receiver voltage U depends on the relative position between the scanning apparatus 20 and the material measure 11.

Each measurement channel has a separate associated A/D converter 32, which has a sampling rate which is considerably higher than the frequency of the alternating current which is fed into the transmitter turn arrangement 21. The receiver voltage U is converted by the A/D converter 32 to a sequence of digital values yᵢ. The amplitude of the two receiver voltages U is determined by different digital computation operations, which are carried out by the position determination means 33. The phase angle of the scanning apparatus 20 with respect to the material measure 11 can be determined from these two amplitudes by an arctan calculation.

A position signal 34 is synthesized from said phase angle and may selectively have one of different standardized formats. In this case, in particular, these are analog sine/cosine signals, incremental TTL signals or digital absolute signals. If analog signals are output, these typically have a smaller basic graduation interval than the material measure 11. It should also be noted that all the digital operations by the evaluation apparatus 35 are carried out by an FPGA (field programmable gate array), in order to provide the required computation power.

During the test operation according to the disclosure, the switch 24 is opened, as a result of which no current flows through the transmitter turn arrangement 21, and accordingly no electromagnetic alternating field is produced. In this operating state, the receiver voltage U is caused mainly by the thermal noise, also referred to as Johnson Nyquist noise, resulting from the resistance of the receiver turn arrangement 30. The receiver turn arrangement 30 has a very large number of turn revolutions, as a result of which its sensitivity is high. The resistance, and therefore said thermal noise, are correspondingly high. In particular, it is sufficiently high that the sensitivity of the A/D converter 32 is sufficient to digitize this. At the same time, the sampling rate of the A/D converter 32 is sufficiently high for the digital sample values yᵢ to contain information relating to the spectral composition of the thermal noise.

Each measurement channel has an associated noise evaluation unit 40 according to the disclosure, each of which is designed to be identical. First of all, the sample values yᵢ are filtered by means of a digital bandpass filter 41, as a result of which the further evaluation is restricted to frequency ranges in which no disturbance signals may be expected. A noise measure determination means 42 then determines a noise measure R, which can be calculated, for example, using the formulae:

$$R = \frac{1}{N} {{\sum }_{i = m}}^{m + N} {y}_{i}^{2} or$$

$$R = \frac{1}{N} {{\sum }_{i = m}}^{m + N} \vert {y}_{i} \vert$$

In this case, N is the number of sample values yᵢ included in the present calculation. A comparison means is then used to check whether the condition

min<R<max

is or is not satisfied. The limit values of the tolerance band min and max may in this case selectively be permanently programmed into the evaluation apparatus or may be subsequently variable, in order to allow the evaluation apparatus to be matched to different sensor types. The limit values min and max are preferably determined by experiments.

The limit values min and max may, furthermore, be corrected on a temperature-dependent basis. A temperature sensor 44 which measures the temperature of the receiver turn arrangement 30 is for this purpose arranged in the region of the receiver turn arrangement 30. The limit values min and max are corrected by multiplying them by the following correction factor:

$$k = \sqrt{\frac{T}{{T}_{o}}}$$

In this case, T is the temperature measured by the temperature sensor 44 in Kelvin, with T₀ being the temperature at which the stored limit values min and max need not be corrected.

In the embodiment illustrated in FIG. 1, a monitoring light is provided as the indication means 45. Additionally or alternatively, the evaluation apparatus 35 may have a fault signal connection at which an appropriate fault signal is output, which can be processed by a superordinate control system. Furthermore, the position signal 34 may be set to a state which indicates a malfunction of the position measurement apparatus 10.

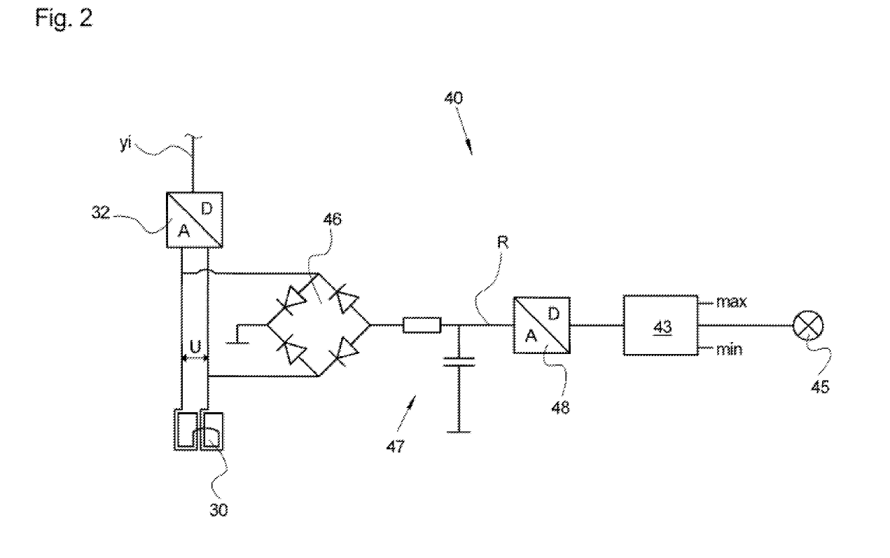

FIG. 2 shows a second embodiment of a position measurement apparatus according to the disclosure, in which only one of the noise evaluation units 40 is illustrated. Apart from this, the second embodiment is identical to the first embodiment shown in FIG. 1, as a result of which reference can be made to the above statements. Once again, the noise evaluation units 40 for both measurement channels are designed identically.

The second embodiment is preferably used when the main A/D converter 32 does not have a sufficiently high sampling frequency to determine the noise measure R completely digitally. This is the case in particular when the receiver voltage is sampled phase-synchronously. In this case, the receiver voltage U is sampled in synchronism with the alternating current fed into the transmitter turn arrangement. Therefore, the sample values yᵢ are always related to a predetermined phase angle, preferably the magnitude maximum, of the receiver voltage U. The amplitude of the receiver voltage U required for position determination is therefore actually determined directly during the A/D conversion.

The possibly amplified receiver voltage U is therefore supplied to a rectifier 46, which operates on an analog basis and is illustrated, purely by way of example, as a bridge rectifier. The rectified voltage is then low-pass-filtered 47. The low-pass filter 47 is, once again purely by way of example, illustrated as an RC low-pass filter. The analog noise measure R obtained in this way is now compared with the limit values min and max for the permissible tolerance band. In the illustrated exemplary embodiment, this is done digitally using a separate noise A/D converter 48. However, the comparison can just as well be carried out in a purely analog form.

### LIST OF REFERENCE SYMBOLS

λ Graduation interval
R noise measure
yᵢ Sample value
U Receiver voltage
10 Position measurement apparatus
11 Material measure
12 Measurement marking
20 Scanning apparatus
21 Transmitter turn arrangement
22 Transmitter area
23 Transmitter current source
24 Switch
30 Receiver turn arrangement
31 Receiver core pair
32 (Main) A/D conversion
33 Position determination means
34 Position signal
35 Evaluation apparatus
40 Noise evaluation unit
41 Filter
42 Noise measure determination means
43 Comparison means
44 Temperature sensor
45 Indication means
46 Rectifier
47 Low-pass filter
48 Noise A/D converter

What is claimed is:

1. A position measurement apparatus comprising:
a material measure;
a scanning apparatus, which can move with respect to the material measure, with the scanning apparatus having at least one receiver turn arrangement, by means of which measurement markings on the material measure can be scanned, with the scanning apparatus furthermore having an evaluation apparatus which can measure the electrical receiver voltage which is pressed on the receiver turn arrangement, in order to produce a position signal therefrom, the evaluation apparatus being designed to determine a noise measure from the receiver voltage; and
a comparison means, which can compare the noise measure with a predeterminable tolerance band,
wherein the evaluation apparatus further includes an indication means which can indicate that the noise measure is outside the tolerance band.

2. The position measurement apparatus according to claim 1, wherein the noise measure is the square of the receiver voltage averaged over a predeterminable time period.

3. The position measurement apparatus according to claim 1, wherein the noise measure is the magnitude of the receiver voltage averaged over a predeterminable time period.

4. The position measurement apparatus according to claim 1, wherein the evaluation apparatus comprises an analog/digital converter for measurement of the receiver voltage, with the noise measure being determined and compared with the tolerance band digitally.

5. The position measurement apparatus according to claim 1, wherein the evaluation apparatus has a bandpass filter, thus allowing the receiver voltage to be filtered before determination of the noise measure.

6. The position measurement apparatus according to claim 1, wherein the evaluation apparatus is designed such that it can check the receiver voltage to determine whether it has the same spectral composition as white noise.

7. The position measurement apparatus according to claim 1, wherein the scanning apparatus has a temperature sensor for measurement of the temperature of the receiver turn arrangement, in which case the tolerance band can be corrected as a function of the measured temperature.

8. The position measurement apparatus according to claim 1, wherein the scanning apparatus has a transmitter turn arrangement which is connected to a transmitter current source, in which case the connection to the transmitter current source can be blocked during determination of the noise measure.

9. The position measurement apparatus according to claim 1, wherein the scanning apparatus is designed such that the indication means can set the position signal to a state which indicates a malfunction of the position measurement apparatus.
